(19) United States
(12) Patent Application Publication
(10) Pub. No.: US 2014/0281876 A1
(43) Pub. Date: Sep. 18, 2014

(54) DOCUMENT ELEMENT MAPPING

(71) Applicant: Meteor Development Group, Inc., San Francisco, CA (US)

(72) Inventors: Geoffrey Robert Schmidt, San Francisco, CA (US); Nicholas Martin, Berkeley, CA (US); Matthew DeBergalis, San Francisco, CA (US); David Greenspan, Oakland, CA (US)

(21) Appl. No.: 13/837,056

(22) Filed: Mar. 15, 2013

(51) Int. Cl. G06F 17/24

(52) U.S. Cl. CPC G06F 17/241
USPC 715/230

(57) ABSTRACT

Briefly, embodiments disclosed herein may relate to annotating a online application template string to specify a range of one or more data records based, at least in part, on a current data context.

### BACKGROUND

1. Field

Subject matter disclosed herein may relate to mapping electronic document elements and may relate, more particularly, to mapping associations between electronic document elements and data records, for example.

2. Information

The success of World Wide Web (Web) type applications continues to change the way the Internet, in general, and the Web, in particular, is utilized. Rather than being merely a convenient way to publish, for example, web pages may be transformed into Web-type computing devices and/or platforms. Compared with desktop applications, systems, such as systems online via the Web, may bring benefits such as, for example, universal accessibility and the ability and/or an ability to readily share, cooperate, and/or communicate with others. Thus, continuing to improve performance remains desirable, as does promoting ease of programming for Web-type application developers, for example.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic diagram illustrating an example system for generating and/or updating a web page for an online application according to an embodiment.

FIG. 2 is a diagram illustrating an example system for mapping associations between one or more data records and one or more document components, in accordance with an embodiment.

FIG. 3 is an illustration depicting an example online application display in accordance with an embodiment.

FIG. 4a is a schematic diagram illustrating an example hierarchy of ranges of document components in accordance with an embodiment.

FIG. 4b is a schematic diagram illustrating an example template describing hierarchy of ranges of document components in accordance with an embodiment.

FIG. 5 is a flow diagram depicting an example process in accordance with an embodiment.

FIG. 6 is a block diagram illustrating an example system comprising a plurality of computing devices coupled via a network in accordance with an embodiment.

Reference is made in the following detailed description to accompanying drawings, which form a part hereof, wherein like numerals may designate like parts throughout to indicate corresponding and/or analogous components. It will be appreciated that components illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

Reference throughout this specification to one implementation, an implementation, one embodiment, an embodiment and/or the like may mean that a particular feature, structure, or characteristic described in connection with a particular implementation or embodiment may be included in at least one implementation or embodiment of claimed subject matter. Thus, appearances of such phrases, for example, in various places throughout this specification are not necessarily intended to refer to the same implementation or to any one particular implementation described. Furthermore, it is to be understood that particular features, structures, or characteristics described may be combined in various ways in one or more implementations. In general, of course, these and other issues may vary with context. Therefore, particular context of description or usage may provide helpful guidance regarding inferences to be drawn.

Operations and/or processing, such as in association with networks, such as communication networks, for example, may involve physical manipulations of physical quantities. Typically, although not necessarily, these quantities may take the form of electrical and/or magnetic signals capable of, for example, being stored, transferred, combined, processed, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these or similar terms are to be associated with appropriate physical quantities and are intended to merely be convenient labels.

Likewise, in this context, the terms “coupled”, “connected,” and/or similar terms, may be used. It should be understood that these terms are not intended as synonyms. Rather, “connected” may be used to indicate that two or more elements or other components, for example, are in direct physical and/or electrical contact; while, “coupled” may mean that two or more components are in direct physical or electrical contact; however, “coupled” may also mean that two or more components are not in direct contact, but may nonetheless co-operate or interact. The term coupled may also be understood to mean indirectly connected, for example, in an appropriate context.

The terms, “and”, “or”, “and/or” and/or similar terms, as used herein, may include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms may be used to describe any feature, structure, and/or characteristic in the singular and/or may be used to describe a plurality or some other combination of features, structures and/or characteristics. Though, it should be noted that this is merely an illustrative example and claimed subject matter is not limited to this example. Again, particular context of description or usage may provide helpful guidance regarding inferences to be drawn.

It should be understood that for ease of description a network device may be embodied and/or described in terms of a computing device. However, it should further be understood that this description should in no way be construed that claimed subject matter is limited to one embodiment, such as a computing device or a network device, and, instead, may be embodied as a variety of devices or combinations thereof, including, for example, one or more illustrative examples.

In this context, the term network device refers to any device capable of communicating via and/or as part of a network. Network devices may be capable of sending and/or receiving signals (e.g., signal packets), such as via a wired or wireless network, may be capable of performing arithmetic and/or logic operations, processing and/or storing signals, such as in memory as physical memory states, and/or may, for example, operate as a server. Network devices capable of operating as a server, or otherwise, may include, as examples, dedicated rack-mounted servers, desktop computers, laptop computers, set top boxes, tablets, netbooks, smart phones, integrated devices combining two or more features of the foregoing devices, the like or any combination thereof.

A network may comprise two or more network devices and/or may couple network devices so that signal communications, such as in the form of signal packets, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices or one or more server devices, as appropriate. Along similar lines, references to a “database” are understood to mean, one or more databases and/or portions thereof, as appropriate.

A network may also include now known, or to be later developed arrangements, derivatives, and/or improvements, including, for example, past, present and/or future mass storage, such as network attached storage (NAS), a storage area network (SAN), and/or other forms of computer and/or machine readable media, for example. A network may include the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures or may be compliant and/or compatible with differing protocols, such as communication protocols (e.g., network communication protocols), may interoperate within a larger network. Various types of devices may be made available so that device interoperability is enabled and/or, in at least some instances, may be transparent to the devices. In this context, the term transparent refers to devices communicating via a network in which the devices are able to communicate via intermediate devices, but without the communicating devices necessarily specifying one or more intermediate devices and/or may include communicating as if intermediate devices are not necessarily involved in communication transmissions. For example, a router may provide a link between otherwise separate and/or independent LANs. In this context, a private network refers to a particular, limited set of network devices able to communicate with other network devices in the particular, limited set, such as via signal packet transmissions, for example, without a need for re-routing and/or redirecting such communications. A private network may comprise a stand-alone network; however, a private network may also comprise a subset of a larger network, such as, for example, without limitation, the Internet. Thus, for example, a private network “in the cloud” may refer to a private network that comprises a subset of the Internet, for example. Although signal packet transmissions may employ intermediate devices to exchange signal packet transmissions, those intermediate devices may not necessarily be included in the private network by not being a source or destination for one or more signal packet transmissions, for example. As another example, a logical broadcast domain may comprise an example of a private network. It is understood in this context that a private network may provide outgoing communications to devices not in the private network, but such devices outside the private network may not direct inbound communications to devices included in the private network.

The Internet refers to a decentralized global network of interoperable networks, including devices that are part of those interoperable networks. The Internet includes local area networks (LANs), wide area networks (WANs), wireless networks, and/or long haul public networks that, for example, may allow signal packets to be communicated between LANs. The term world wide web (WWW) and/or similar terms may also be used to refer to the Internet. Signal packets, also referred to as signal packet transmissions, may be communicated between nodes of a network, where a node may comprise one or more network devices, for example. As an illustrative example, but without limitation, a node may comprise one or more sites employing a local network address. Likewise a device, such as a network device, may be associated with that node. A signal packet may, for example, be communicated via a communication channel or a communication path comprising the Internet, from a site via an access node coupled to the Internet. Likewise, a signal packet may be forwarded via network nodes to a target site coupled to a local network, for example. A signal packet communicated via the Internet, for example, may be routed via a path comprising one or more gateways, servers, etc. that may, for example, route a signal packet in accordance with a target address and availability of a network path of network nodes to a target address.

Physically connecting a network via a hardware bridge as one example may be done, although other approaches also exist. A hardware bridge, however, may not typically include a capability of interoperability via higher levels of a network protocol. A network protocol refers to a set of signaling conventions for communications between or among devices in a network, typically network devices; for example, devices that substantially comply with the protocol or that are substantially compatible with the protocol. In this context, the term “between” and/or similar terms are understood to include “among” if appropriate for the particular usage. Likewise, in this context, the terms “compatible with”, “comply with” and/or similar terms are understood to include substantial compliance or substantial compatibility.

Typically, a network protocol has several layers. These layers may be referred to here as a communication stack. Various types of communications may occur across various layers. For example, as one moves higher in a communication stack, additional functions may be available by transmitting communications that are compatible and/or compliant with a particular network protocol at these higher layers. In contrast, a virtual private network (VPN) may enable a remote device to communicate via a local network. A router may allow communications in the form of transmissions (e.g., signal packets), for example, to occur from a remote device to a VPN server on a local network. A remote device may be authenticated and a VPN server, for example, may create a special route between a local network and the remote device through an intervening router.

Although claimed subject matter is not in particular limited in scope to the Internet or to the web, it may without limitation provide a useful example of an embodiment for purposes of illustration. As indicated, the Internet may comprise a worldwide system of interoperable networks, including devices within those networks. The internet has evolved to a public, self-sustaining facility that may be accessible to tens of millions of people or more worldwide. Also, in an embodiment, a widely used part of the Internet may comprise the World Wide Web, often abbreviated “WWW” or simply referred to as just “the web”. As mentioned, the terms Internet, web and/or similar terms may, therefore, be used interchangeably. The web, therefore, in this context, may comprise an Internet service that organizes stored content, such as, for example, text, images, video, etc., through the use of hypermedia. For example, a HyperText Markup Language (“HTML”) may be utilized to specify content and/or format of hypermedia type content, such as in the form of a file or an “electronic document,” such as a web page, for example. An Extensible Markup Language (XML) may also be utilized to specify content and/or format of hypermedia type content, such as in the form of a file or an “electronic document,” such as a web page, in an embodiment. Of course, HTML and XML are merely example languages provided as illustrations. Claimed subject matter is not intended to be limited to examples provided as illustrations, of course.

As used herein, a “web site” may refer to a collection of related web pages, in an embodiment. Also as used herein, “web page” may relate to any electronic file or electronic document, such as may be accessible via a network, by specifying a URL for accessibility via the web, in an example embodiment. As alluded to above, in one or more embodiments, a web page may comprise content coded using one or more languages, such as, for example, HTML and/or XML, although claimed subject matter is not limited in scope in this respect. Also, in one or more embodiments, application developers may write code in the form of JavaScript, for example, to provide content to populate one or more templates, such as for an application. However, JavaScript is merely an example programming language. As was mentioned, claimed subject matter is not limited to examples or illustrations.

As used herein, the term “entry”, “electronic entry”, “document”, “electronic document” and/or similar terms are meant to refer to signals and/or states in a digital format that may be perceived by a user if displayed by a digital device, such as, for example, a computing device. For one or more embodiments, an electronic document may comprise a web page coded in a markup language, such as, for example, HTML (hypertext markup language). In another embodiment, an electronic document may comprise a portion or a region of a web page. However, claimed subject matter is not limited in these respects. Also, for one or more embodiments, an electronic document or electronic entry may comprise a number of components. Components in one or more embodiments may comprise text, for example as may be displayed on a web page. Also for one or more embodiments, the components may comprise a graphical object, such as, for example, a digital image, or sub-objects, such as attributes thereof.

As mentioned, the success of World Wide Web (web) type applications, which may be referred to herein as “online applications”, continue to change the way the Internet, in general, and the Web, in particular, is utilized. Web pages may be transformed into Web-type computing devices. Compared with desktop applications, systems, such as systems online via the web, for example, may bring benefits, such as universal accessibility and/or an ability to readily share, cooperate and/or communicate with others. However, development of web-type applications may typically involve a programmer solving many issues and problems that may arise due to difficulties in tracking data association and/or dependency issues, for example. A programmer may need to write code to track various associations between data records, for example, and respective document components within an application, for example. Such associations may be complex in many situations.

In typical practice for conventional online application development, a template may be executed at a point in time, thereby producing an HTML string, for example, that may reflect a state of the application at that point in time. A state of an online application may reflect return values of JavaScript code, for example, that may provide values for variables defined in a template, and also may reflect current values of data fields referenced in a template. An HTML string reflecting a state of an online application may be parsed into a tree of its constituent elements by a web browser executed on an end-user computing device, for example, and displayed on a display screen. To track associations between data records and respective document components, mappings between data records and respective document components may be maintained over the course of different stages of a document component's life by an online application. For example, mappings between data records and respective document components may be maintained from a time an element is specified, for example as an HTML string in a template, and a time it is constructed, for example as a document object model (DOM) node within a DOM tree. Mappings between data records and respective document components may further be maintained once a document element has been constructed and is part of a displayed document, for example in response to a document DOM being executed by a web browser.

For conventional online application development practice, mappings between data records and document components may be maintained by an application programmer providing explicit directives to associate data records with document components. For example, an application programmer may write code to track changes to some or all mappings between data records and document components. Tracking data associations for an electronic document as the electronic document goes through stages of template specification creation, template instantiation, DOM generation, and DOM execution may pose significant challenges to an online application developer.

In an embodiment in accordance with claimed subject matter, an online application system may include techniques for associating data records in a form of objects in memory with document component specifications in a form of text, and for maintaining associations between data records and regions of a document that may be determined at a time a document component may be specified. In an embodiment, mappings between data records and document components may be automatically maintained, thereby eliminating or reducing an application programmer's need to explicitly map and/or track associations between data records and document components.

FIG. 1 is a diagram illustrating an example system 100 for generating and/or updating a web page for an online application, including mapping associations between one or more data records and one or more document components, in accordance with an embodiment. Online application 110, in an embodiment, may represent any type of online application. Example online applications may include, for example, banking applications or social networking sites, although any of a wide range of online application types are possible. An example application of a photo gallery is described herein. However, specific online applications discussed herein are merely examples, and claimed subject matter is not limited in this respect.

In an embodiment, online application 110 may comprise one or more templates. Individual templates may contain a specification of template contents, such as template specification 113, and may also include online application developer's programming code to supply data to an instantiated template, such as instantiated template 130. A template, as referred to herein, may comprise a computer program or other description that may specify document components, for example that make up a user interface for an application, in terms of data records, calculations on data records, and/or other sources of information. In an embodiment, a template, such as instantiated template 130, may comprise a string of HTML code that may be utilized by a web browser, such as browser 140, for example, to construct document elements.

Further, in an embodiment, at least in part in response to a template specification, such as template specification 113, being instantiated, an instantiated template 130 may be rendered to generate a tree of DOM nodes, such as DOM tree 142, comprising parsed HTML elements that are to be displayed to an end-user. DOM tree 142 may comprise a snapshot of a current state of instantiated template 130. In an embodiment, a web browser, such as browser 140, may generate display pixels from DOM nodes with an addition of other resources such as image files and Cascading Style Sheets (CSS) styling directives, for example. Pixel information may be stored in a frame buffer, and pixels may be displayed on an end user display device, for example.

In an embodiment, a document component may comprise at least a portion of an electronic document, such as, for example, a web page. In an embodiment, a document component may comprise a node of a DOM tree, such as DOM tree 142, corresponding to a web page, and may be presented to a JavaScript program running in a web browser, such as browser 140, for display to a user. Example document components may include, for example, a checkbox, a text field, an icon, a row of a table, a user interface component, an HTML link, and so on. Of course, these are merely example document components, and claimed subject matter is not limited in scope in this respect. Also, in an embodiment, document components may exist in a hierarchy, or tree, as explained more fully below.

As mentioned previously, embodiments in accordance with claimed subject matter may comprise web browser, such as browser 140, and a user application, such as online application 110. In one or more embodiments, a browser, such as browser 140, and an application, such as online application 110, may be executed within the same computing platform. For example, web browser 140 and online application 110 may be executed on a laptop computer, for example, or on a cellular telephone, for another example. In other embodiments, all or a portion of online application 110 may be executed on a server computing platform, for example, and browser 140 may be executed on an end-user computing platform.

As used herein, a document element may be said to be “specified” when it is fully described in a manner that may lead to its construction, such as in a text string. For example, a string “<hr>” may specify a single horizontal rule component in HTML code. When interpreted by a web browser, a text string such as “<hr>” may lead to construction of a horizontal rule document component. In an embodiment, a JavaScript program running in a web browser may construct document components directly, which may comprise document component specification and construction in a single step. Of course, “<hr>” is merely an example document component, and claimed subject matter is not limited in scope in this respect.

Further, as used herein, an “event” may comprise a representation of an action. For example, an event may comprise a user action, such as a key press or a mouse click. In response to an event, an event handler, such as event handler 114, may be invoked by an application, such as online application 110. In an embodiment, an event handler may receive information related to an event, such as, for example, information associating one or more document components with an event. For example, a mouse click event may have associated with it a document component that a user may have selected. A document component specified by a mouse click, for example, may be referred to as a target document component.

In an embodiment, an online application, such as online application 110, may access one or more data sources, such as data records 120. In an embodiment, individual data records may represent entities with which a user may interact through an online application. Also, in an embodiment, a data record may comprise information to specify one or more document components. Further, in an embodiment, a data record may be implemented as a JavaScript object, although claimed subject matter is not limited in scope in these respects.

FIG. 2 is a diagram illustrating an example system for mapping associations between one or more data records and one or more document components, in accordance with an embodiment. In an embodiment, an example template, such as template 230, for an example photo gallery online application, may comprise the following, although claimed subject matter is not limited in scope in these respects:

```
{{#with currentAlbum}}
    <div ...
      <div class=”banner”>
                {{name}}
      </div>
      <div class=”thumbnails”>
          {{#each getPhotos}}
              <span>{{refNum}}</span>
              <img src=“/thumbs/{{id}}.jpg” ...
                {{/each}}
        </div>
    </div>
{{/with}}
```

In an embodiment, an example photo gallery online application may include a template, such as template 230, that may be utilized by an online application framework to generate HTML code based, at least in part, on contents of one or more data records such as, for example, an Album data record and/or one or more Photo data records. In an embodiment, a template, such as template 230, may be represented in a “Handlebars” format, although claimed subject matter is not limited in scope in this respect. In an additional aspect, a template, such as template 230, may interleave HTML code with directives enclosed in curly brackets such as “{{with}}” that may be replaced by HTML code by a “Handlebars” interpreter. In an embodiment, “Handlebars” constructs such as “{{#with}}” and/or “{{#each}}” may surround individual blocks of code and may establish one or more particular data records as respective data contexts for individual blocks of code.

For example, template 230 may comprise a block of code depicted in FIG. 2 as being contained within a box labeled “Context A”. In an embodiment, for code within box “Context A”, a particular album may comprise a current data context to which a data record specified by “{{name}}” may be associated. For code within box “Context B”, a particular thumbnail photograph represented by an identification number “{{id}}” may be designated as a current data context for individual passes through that particular code segment, for example.

Also, in an embodiment, a set of definitions for individual variables in a template, for example “name”, “refNum”, and “id” in the example provided above and depicted in FIG. 2, may be provided in a programming language such as JavaScript. In an embodiment, a templating engine may call out to code, such as JavaScript code, for example, to retrieve values to populate a template.

Continuing with the example “Handlebars” and JavaScript-based embodiment discussed above, template variables may receive their value in any of a number of ways. For example, template variables may comprise what may be referred to as “helpers”, such as Helpers 220. Individual helpers may be associated with JavaScript code that programmatically may provide a value of a respective individual variable. In an embodiment, a helper may comprise a JavaScript procedure that if executed may return a value to be used for a variable at a particular point in time, or it may comprise a JavaScript expression that may provide a final value for a variable.

In an embodiment, a name of a variable may be interpreted to comprise a “data field” in response to not matching any defined helper, for example. A data field may refer to an attribute of a “current object” in a template. For example, inside an {{#each}}block, a “current object” may comprise an object being referenced by a particular repetition of a block. Referring to the photo gallery example mentioned above, {{id}} may comprise an example of a “data field”, referring to an identification number attribute of a respective thumbnail photograph object in a database for individual repetitions of an “{{#each}}” block. In an embodiment, at least in part in response to multiple {{#each}}blocks being nested, a current data context may be determined by the innermost {{#each}}block, for example, although claimed subject matter is not limited in scope in this respect.

Also depicted in FIG. 2 is an example browser document object model (DOM) 240 comprising various document components. In an embodiment, a document component may comprise portions of an electronic document that may be interacted with by a user. For example, some document components may be viewed by a user, and other document components may be provided in a user interface to allow a user to provide input, for example by way of a mouse click. Also, in an embodiment, a document component may comprise a DOM node for a web page that may be presented to a JavaScript program executed in a web browser. For the example photo gallery online application discussed above, document elements may include DOM elements labeled DIV, SPAN, and IMG. Of course, these are merely example document component types, and claimed subject matter is not limited in scope in these respects.

FIG. 2 also depicts example data records 210, including an album data record and example photo data records. As depicted in FIG. 2, an example album data record may be associated with context A, so designated during execution of an example “{{#with}}” directive depicted in example template 230. Individual photo data records may be associated with respective “B” data contexts, labeled respectively as “B1” and “B2”. Individual photo data records may become associated with respective individual data contexts during individual iterations of an example “{{#each}}” loop depicted in example template 230.

FIG. 3 is an illustration depicting an example electronic document 300 in accordance with an embodiment. In an embodiment, electronic document 300 may comprise a web page DOM, such as, for example, DOM 240, that has been executed by a web browser, such as browser 140, and displayed to a user by way of a display device of a computing device. In an embodiment, electronic document 300 may comprise a DIV component 310, a DIV component 320 associated with an album name data record, and a DIV component 330 specifying a region of document 300 for displaying thumbnail images. Further, in an embodiment, electronic document 300 may comprise SPAN components 340 and IMG components 350. For the example embodiment depicted in FIGS. 2 and 3, and as described above, individual iterations of a loop, such as that specified by an “{{#each}}” directive in example template 230, may result in separate data contexts being assigned to variables, such as variables “refNum” and “id”, for example.

As mentioned previously, utilizing conventional online application development techniques, a programmer would have to write code to track various data dependencies and associations for electronic documents generated by an online application. Tracking data associations as an electronic document goes through stages of template specification creation, template instantiation, DOM generation, and DOM execution may pose significant challenges to an online application developer.

To make online application development easier and more efficient, associations between document components and data records may be automatically managed. For example, in accordance with an embodiment, an online application may generate an HTML string that may specify a hierarchical electronic document component structure. As described previously, a current data context may be active at any given point of a template. For example, at any given point of a template, an individual data context may be associated with a respective document component. In an embodiment, nested regions of a template may produce nested regions of a DOM tree, and data contexts associated with nested regions of a DOM tree may be automatically tracked.

Browser DOM 240 of FIG. 2 depicts an example DOM tree with nested regions. For the example of FIG. 2, browser DOM 240 may be conceptualized as brackets labeled Range A, Range B1, and Range B2, as depicted in FIG. 2. It is noted that Context B, depicted in template 230 of FIG. 2, may result in multiple range instantiations due at least in part to a loop defined in this example by an “{{#each}}” directive.

In an embodiment, generation of an electronic document by an online application may comprise multiple stages. For example, a first stage may comprise one or more document components that have not yet been constructed, but rather only exist as a text string, for example. In a second stage, an online application may construct a DOM tree based on the text string. In some embodiments, an online application may directly generate a DOM tree, without going through a first stage.

FIG. 4a is a schematic diagram illustrating an example hierarchy of ranges of document components in accordance with an embodiment, and FIG. 4b is a schematic diagram illustrating an example template describing hierarchy of ranges of document components in accordance with an embodiment. In an embodiment, to track associations between document components and data records if an electronic document exists as one or more nodes of a DOM tree, such as if an electronic document is in a second stage as described above, a technique referred to herein as “LiveRanges” may be utilized. In an embodiment, LiveRanges may represent a hierarchy of ranges of document components at least in part by attaching data structures directly to document components. For example, FIG. 4a depicts two-level hierarchical structure 400 of document components corresponding to an example template 410 depicted in FIG. 4b. For the example of FIGS. 4a and 4b, hierarchical structure 400 may comprise LiveRanges 401, 402, 403, 404, and 405.

In an embodiment, a LiveRange may conceptually comprise a container that encloses a range of one or more siblings and their descendants in a DOM tree. Also, in an embodiment, a LiveRange may comprise pointers to a first element and to a last element of that LiveRange. A LiveRange may comprise a “firstNode” pointer and a “lastNode” pointer, and individual document components may comprise two arrays of pointers, in an embodiment. For example, bidirectional pointers may be represented in FIG. 4a by dotted lines. Also, in FIG. 4a, an individual LiveRange's pointers are represented by two dots. An individual document component's two arrays of pointers are represented in FIG. 4a by dots located in the upper left or upper right corners of an individual document component's box.

In an embodiment, LiveRange pointers may be utilized to determine which LiveRange contains a particular document element. Further, in an embodiment, LiveRanges may be evaluated from an inner-most LiveRange to an outer-most LiveRange to determine which document components may be associated with individual LiveRanges. In an embodiment, LiveRanges may be generated for individual data contexts encountered during template instantiation. Also, in an embodiment, a data record associated with a particular document component may comprise a data record of an innermost LiveRange containing the particular document component.

Although embodiments described herein may comprise LiveRanges incorporating bi-directional pointers, other embodiments may utilize uni-directional pointers. For embodiments incorporating uni-directional pointers, pointers may be maintained from LiveRanges to DOM nodes, and may not be maintained from DOM nodes to LiveRanges. By not maintaining pointers from DOM nodes to LiveRanges, embodiments that may not allow modification of DOM nodes may be implemented. Further, in embodiment incorporating uni-directional pointers, LiveRanges may be evaluated from an outer-most LiveRange to an inner-most LiveRange to determine which document components may be associated with individual LiveRanges.

In an embodiment, string annotations may be utilized to mark ranges of an HTML string to memorialize associations between portions of an HTML string and data records. Also, in an embodiment, string annotations may be generated automatically, without online application developer involvement. Additionally, in an embodiment, string annotations may be generated in a manner so as to not interfere with conventional web browser behavior, for example.

In an embodiment, marker strings may be inserted into a template represented as a string of HTML code. During post-processing, inserted marker strings may be searched to determine document component mappings to data records. In the following example string, HTML tags, such as “<h1>”, may be generated by an online application in a conventional fashion. Additional marker strings, such as “<$data:DeNaSPSb>” may be generated and inserted into the HTML string to permit tracking of document component mappings to data records. For example:

```
<$data:DeNaSPSb>
  <h1>Heading</h1>
    <$data:95xxhodi>
      <ul>
        <$data:0a4xeVJ7>
          <$data:Z47YUivW>
            <li>Item 1</li>
          </$data:Z47YUivW>
        <$data:X0_Pw+Zq>
          <li>Item 2</li>
        </$data:X0_Pw+Zq>
      </$data:0a4xeVJ7>
    </ul>
  </$data:95xxhodi>
<$data:DeNaSPSb>
```

Referring to the example string presented above, marker strings inserted into the HTML string may be searched during post-processing to locate inserted strings, and the inserted strings may be utilized to guide construction of a document with appropriate LiveRanges. In an embodiment, marker strings are not passed on to a web browser, while the original HTML string is passed to a web browser where they may be processed in a conventional fashion. For the example above, a web browser would be instructed to construct a document sub-tree comprising of “<Ii>Item1</Ii>”, and then the web browser would be instructed to attach an appropriate LiveRange to Item1. The web browser may subsequently be instructed to construct a document sub-tree comprising of “<Ii>Item2</Ii>”, and then the web browser would be instructed to attach an appropriate LiveRange to Item2. In an embodiment, a web browser may assemble the two sub-trees for this example into a single hierarchy, and an additional LiveRange may also be applied. Of course, the HTML and marker string constructs utilized above are merely examples, and claimed subject matter is not limited in scope in these respects.

In an additional embodiment, HTML comments may be inserted into an HTML string. In an embodiment, HTML comments may include information similar to the marker strings discussed above. However, because a web browser will ignore HTML comments, there is no need to remove inserted comments, and inserted comments may be passed on to a web browser during document creation.

In a further embodiment, rather than insert HTML comments into an HTML string, and rather than inserting marker strings into an HTML string, locations at which marker strings would have been inserted may be remembered so that appropriate LiveRanges may be generated during document creation. For example, referring again to the example string presented above, a first range may begin at an offset location of 0, indicating a location immediately preceding “<h1>”, and a second range may begin at an offset of 16, immediately following “</h1>”. Information similar to that utilized for marker strings, for example, may be stored so that appropriate LiveRanges may be constructed during document creation.

FIG. 5 is a flow diagram depicting an example process in accordance with an embodiment. As depicted at block 510, an online application template may be annotated to specify a range of one or more data records based, at least in part, on a current data context. At block 520, document components may be constructed from the template string at least in part by passing the string to a web browser and by attaching one or more LiveRanges to the document components. Additionally, in an embodiment, in response to an event occurring at block 530, an innermost enclosing LiveRange may be determined at block 540 to obtain a pointer to an appropriate data record. Claimed subject matter may include all of, less than, or more than blocks 510-540. Further, the order of blocks 510-540 depicted in FIG. 5 is merely an example order, and claimed subject matter is not limited in scope in these respects.

FIG. 6 is a block diagram illustrating an example system comprising a plurality of computing devices coupled via a network in accordance with an embodiment. For purposes of illustration, FIG. 6 is an illustration of an embodiment of a computing platform or computing device 604 that may be employed in a client-server type interaction, such as described infra. In FIG. 6, server 604 may interface with a client 602, which may comprise features of a conventional client device, for example. Communications interface 630, processor (e.g., processing unit) 620, and memory 622, which may comprise primary memory 624 and secondary memory 626, may communicate by way of communication bus 628, for example. In FIG. 6, client device 602 may store various forms of content, such as analog, uncompressed digital, lossless compressed digital, or lossy compressed digital formats for content of various types, such as video, imaging, text, audio, etc. in the form physical states or signals, for example. Client 602 may communicate with server 604 by way of an Internet connection via network 608, for example. Although the computing platform 602 of FIG. 6 shows the above-identified components, claimed subject matter is not limited to computing platforms having only these components as other implementations may include alternative arrangements that may comprise additional components, fewer components, or components that function differently while achieving similar results. Rather, examples are provided merely as illustrations. It is not intended that claimed subject matter to limited in scope to illustrative examples.

Processor 620 may be representative of one or more circuits, such as digital circuits, to perform at least a portion of a computing procedure or process. By way of example but not limitation, processor 620 may comprise one or more processors, such as controllers, microprocessors, microcontrollers, application specific integrated circuits, digital signal processors, programmable logic devices, field programmable gate arrays, and the like, or any combination thereof. In implementations, processor 620 may perform signal processing to manipulate signals or states or to construct signals or states, for example.

Memory 622 may be representative of any storage mechanism. Memory 622 may comprise, for example, primary memory 624 and secondary memory 626, additional memory circuits, mechanisms, or combinations thereof may be used. Memory 622 may comprise, for example, random access memory, read only memory, or one or more data storage devices or systems, such as, for example, a disk drive, an optical disc drive, a tape drive, a solid-state memory drive, just to name a few examples. Memory 622 may be utilized to store a program, as an example. Memory 622 may also comprise a memory controller for accessing computer readable-medium 640 that may carry and/or make accessible content, code, and/or instructions, for example, executable by processor 620 or some other controller or processor capable of executing instructions, for example.

Under the direction of processor 620, memory, such as cells storing physical states, representing for example, a program, may be executed by processor 620 and generated signals may be transmitted via the Internet, for example. Processor 620 may also receive digitally-encoded signals from server 604.

Network 608 may comprise one or more communication links, processes, and/or resources to support exchanging communication signals between a client and server, which may, for example, comprise one or more servers (not shown). By way of example, but not limitation, network 608 may comprise wireless and/or wired communication links, telephone or telecommunications systems, Wi-Fi networks, Wi-MAX networks, the Internet, the web, a local area network (LAN), a wide area network (WAN), or any combination thereof.

The term “computing platform,” as used herein, refers to a system and/or a device, such as a computing device, that includes a capability to process and/or store data in the form of signals and/or states. Thus, a computing platform, in this context, may comprise hardware, software, firmware, or any combination thereof (other than software per se). Computing platform 602, as depicted in FIG. 6, is merely one such example, and the scope of claimed subject matter is not limited to this particular example. For one or more embodiments, a computing platform may comprise any of a wide range of digital electronic devices, including, but not limited to, personal desktop or notebook computers, high-definition televisions, digital versatile disc (DVD) players and/or recorders, game consoles, satellite television receivers, cellular telephones, personal digital assistants, mobile audio and/or video playback and/or recording devices, or any combination of the above. Further, unless specifically stated otherwise, a process as described herein, with reference to flow diagrams and/or otherwise, may also be executed and/or affected, in whole or in part, by a computing platform.

Memory 622 may store cookies relating to one or more users and may also comprise a computer-readable medium that may carry and/or make accessible content, code and/or instructions, for example, executable by processor 620 or some other controller or processor capable of executing instructions, for example. A user may make use of an input device, such as a computer mouse, stylus, track ball, keyboard, or any other device capable of receiving an input from a user.

Regarding aspects related to a communications or computing network, a wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, and/or the like, which may move freely, randomly or organize themselves arbitrarily, such that network topology may change, at times even rapidly. Wireless network may further employ a plurality of network access technologies, including Long Term Evolution (LTE), WLAN, Wireless Router (WR) mesh, or 2nd, 3rd, or 4th generation (2G, 3G, or 4G) cellular technology, or other technologies, or the like. Network access technologies may enable wide area coverage for devices, such as client devices with varying degrees of mobility, for example.

A network may enable radio frequency or wireless type communications via a network access technology, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or other, or the like. A wireless network may include virtually any type of now known, or to be developed, wireless communication mechanism by which signals may be communicated between devices, such as a client device or a computing device, between or within a network, or the like.

Communications between a computing device and a wireless network may be in accordance with known, or to be developed cellular telephone communication network protocols including, for example, global system for mobile communications (GSM), enhanced data rate for GSM evolution (EDGE), and worldwide interoperability for microwave access (WiMAX). A computing device may also have a subscriber identity module (SIM) card, which, for example, may comprise a detachable smart card that stores subscription information of a user, and may also store a contact list of the user. A user may own the computing device or may otherwise be its primary user, for example. A computing device may be assigned an address by a wireless or wired telephony network operator, or an Internet Service Provider (ISP). For example, an address may comprise a domestic or international telephone number, an Internet Protocol (IP) address, and/or one or more other identifiers. In other embodiments, a communication network may be embodied as a wired network, wireless network, or combination thereof.

A computing device may vary in terms of capabilities or features. Claimed subject matter is intended to cover a wide range of potential variations. For example, a network device may include a numeric keypad or other display of limited functionality, such as a monochrome liquid crystal display (LCD) for displaying text. In contrast, however, as another example, a web-enabled computing device may include a physical or a virtual keyboard, mass storage, one or more accelerometers, one or more gyroscopes, global positioning system (GPS) or other location-identifying type capability, and/or a display with a higher degree of functionality, such as a touch-sensitive color 2D or 3D display, for example.

A computing device may include or may execute a variety of now known, or to be developed operating systems, or derivatives and/or versions, including personal computer operating systems, such as a Windows, iOS or Linux, or a mobile operating system, such as iOS, Android, or Windows Mobile, or the like. A computing device may include or may execute a variety of possible applications, such as a client software application enabling communication with other devices, such as communicating one or more messages, such as via email, short message service (SMS), or multimedia message service (MMS), including via a network, such as a social network including, but not limited to, Facebook, LinkedIn, Twitter, Flickr, or Google+, to provide only a few examples. A computing device may also include or execute a software application to communicate content, such as, for example, textual content, multimedia content, or the like. A computing device may also include or execute a software application to perform a variety of possible tasks, such as browsing, searching, playing various forms of content, including locally stored or streamed video, or games such as, but not limited to, fantasy sports leagues. The foregoing is provided merely to illustrate that claimed subject matter is intended to include a wide range of possible features or capabilities.

A network including a computing device, for example, may also be extended to another device communicating as part of another network, such as via a virtual private network (VPN). To support a VPN, transmissions may be forwarded to the VPN device. For example, a software tunnel may be created. Tunneled traffic may, or may not be encrypted, and a tunneling protocol may be substantially complaint with or substantially compatible with any past, present or future versions of any of the following protocols: IPSec, Transport Layer Security, Datagram Transport Layer Security, Microsoft Point-to-Point Encryption, Microsoft's Secure Socket Tunneling Protocol, Multipath Virtual Private Network, Secure Shell VPN, or another existing protocol, or another protocol that may be developed.

A network may be compatible with now known, or to be developed, past, present, or future versions of any, but not limited to the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, or X.25. A network may employ, for example, TCP/IP, UDP, DECnet, NetBEUI, IPX, Appletalk, other, or the like. Versions of the Internet Protocol (IP) may include IPv4, IPv6, other, and/or the like.

It will, of course, be understood that, although particular embodiments will be described, claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example (other than software per se). Likewise, although claimed subject matter is not limited in scope in this respect, one embodiment may comprise one or more articles, such as a storage medium or storage media. Storage media, such as, one or more CD-ROMs and/or disks, for example, may have stored thereon instructions, executable by a system, such as a computer system, computing platform, or other system, for example, that may result in an embodiment of a method in accordance with claimed subject matter being executed, such as a previously described embodiment, for example; although, of course, claimed subject matter is not limited to previously described embodiments. As one potential example, a computing platform may include one or more processing units or processors, one or more devices capable of inputting/outputting, such as a display, a keyboard and/or a mouse, and/or one or more memories, such as static random access memory, dynamic random access memory, flash memory, and/or a hard drive.

In the preceding detailed description, numerous specific details have been set forth to provide a thorough understanding of claimed subject matter. However, it will be understood by those skilled in the art that claimed subject matter may be practiced without these specific details. In other instances, methods and/or apparatuses that would be known by one of ordinary skill have not been described in detail so as not to obscure claimed subject matter. Some portions of the preceding detailed description have been presented in terms of logic, algorithms and/or symbolic representations of operations on binary signals or states, such as stored within a memory of a specific apparatus or special purpose computing device or platform. In the context of this particular specification, the term specific apparatus or the like includes a general purpose computing device, such as general purpose computer, once it is programmed to perform particular functions pursuant to instructions from program software.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involves physical manipulation of physical quantities. Typically, although not necessarily, such quantities may take the form of electrical and/or magnetic signals and/or states capable of being stored, transferred, combined, compared, processed or otherwise manipulated as electronic signals and/or states representing information. It has proven convenient at times, principally for reasons of common usage, to refer to such signals and/or states as bits, data, values, elements, symbols, characters, terms, numbers, numerals, information, and/or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing device. In the context of this specification, therefore, a special purpose computer and/or a similar special purpose computing device is capable of processing, manipulating and/or transforming signals and/or states, typically represented as physical electronic and/or magnetic quantities within memories, registers, and/or other information storage devices, transmission devices, and/or display devices of the special purpose computer and/or similar special purpose computing device. In the context of this particular patent application, as mentioned, the term “specific apparatus” may include a general purpose computing device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation and/or a physical change or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

While there has been illustrated and/or described what are presently considered to be example features, it will be understood by those skilled in the relevant art that various other modifications may be made and/or equivalents may be substituted, without departing from claimed subject matter. Additionally, many modifications may be made to adapt a particular situation to the teachings of claimed subject matter without departing from one or more central concept(s) described herein. Therefore, it is intended that claimed subject matter not be limited to the particular examples disclosed, but that such claimed subject matter may also include all aspects falling within appended claims and/or equivalents thereof.

1. A method, comprising:
annotating an online application template string to specify a range of one or more data records based, at least in part, on a current data context.

2. The method of claim 1, wherein said annotating the online application template string comprises inserting one or more string annotations into an HTML string.

3. The method of claim 2, wherein said inserting the one or more string annotations into the HTML string comprises inserting one or more marker strings individually associating a portion of the HTML string and a data record.

4. The method of claim 3, wherein the portion of the HTML string comprises a nested region of the HTML string.

5. The method of claim 1, wherein said annotating the online application template string to specify a range of one or more data records comprises specifying one or more LiveRanges.

6. The method of claim 5, wherein said specifying the one or more LiveRanges comprises specifying a pointer identifying a first document component and a pointer identifying a last document component.

7. The method of claim 5, wherein said specifying the one or more LiveRanges comprises specifying a range of one or more sibling document components and/or one or more descendent document components in a document component tree.

8. The method of claim 1, wherein said annotating the online application template string comprises inserting one or more HTML comments into an HTML string.

9. The method of claim 1, wherein said annotating the online application template string comprises storing an annotation related to a region of the template string at a storage location associated with the region.

10. The method of claim 1, further comprising constructing document components from the online application template string at least in part by attaching one or more LiveRanges to the document components.

11. The method of claim 10, wherein said constructing document components from the online application template string comprises passing the template string to a web browser.

12. The method of claim 11, further comprising determining an innermost enclosing LiveRange to obtain a pointer to an appropriate data record.

13. An apparatus, comprising:
a processor to annotate an online application template string to specify a range of one or more data records based, at least in part, on a current data context.

14. The apparatus of claim 13, the processor to annotate the online application template string at least in part by inserting one or more string annotations into an HTML string.

15. The apparatus of claim 14, the processor to insert the one or more string annotations into the HTML string at least in part by inserting one or more marker strings individually associating a portion of the HTML string and a data record.

16. The apparatus of claim 15, wherein the portion of the HTML string comprises a nested region of the HTML string.

17. The apparatus of claim 13, the processor to annotate the online application template string to specify a range of one or more data records at least in part by specifying one or more LiveRanges.

18. The apparatus of claim 17, the processor to specify the one or more LiveRanges at least in part by specifying a pointer identifying a first document component and a pointer identifying a last document component.

19. The apparatus of claim 17, the processor to specify the one or more LiveRanges at least in part by specifying a range of one or more sibling document components and/or one or more descendent document components in a document component tree.

20. The apparatus of claim 13, the processor to annotate the online application template string at least in part by inserting one or more HTML comments into an HTML string.

21. The apparatus of claim 13, the processor to annotate the online application template string at least in part by storing an annotation related to a region of the template string at a storage location associated with the region.

22. The apparatus of claim 13, the processor further to construct document components from the online application template string at least in part by attaching one or more LiveRanges to the document components.

23. The apparatus of claim 22, the processor further to construct document components from the online application template string at least in part by passing the template string to a web browser.

24. The apparatus of claim 23, the processor further to determine an innermost enclosing LiveRange to obtain a pointer to an appropriate data record.

25. An article, comprising: a storage medium having stored thereon instructions executable by a processor of a computing platform to:
annotate an online application template string to specify a range of one or more data records based, at least in part, on a current data context.

26. The article of claim 25, wherein the storage medium has stored thereon further instructions executable by the processor of the computing platform to annotate the online application template string at least in part by inserting one or more string annotations into an HTML string.

27. The article of claim 26, wherein the storage medium has stored thereon further instructions executable by the processor of the computing platform to insert the one or more string annotations into the HTML string at least in part by inserting one or more marker strings individually associating a portion of the HTML string and a data record.

28. The article of claim 27, wherein the portion of the HTML string comprises a nested region of the HTML string.

29. The article of claim 25, wherein the storage medium has stored thereon further instructions executable by the processor of the computing platform to annotate the online application template string to specify a range of one or more data records at least in part by specifying one or more LiveRanges.

30. The article of claim 29, wherein the storage medium has stored thereon further instructions executable by the processor of the computing platform to specify the one or more LiveRanges at least in part by specifying a pointer identifying a first document component and a pointer identifying a last document component.

31. The article of claim 29, wherein the storage medium has stored thereon further instructions executable by the processor of the computing platform to specify the one or more LiveRanges at least in part by specifying a range of one or more sibling document components and/or one or more descendent document components in a document component tree.

32. The article of claim 25, wherein the storage medium has stored thereon further instructions executable by the processor of the computing platform to annotate the online application template string at least in part by inserting one or more HTML comments into an HTML string.

33. The article of claim 25, wherein the storage medium has stored thereon further instructions executable by the processor of the computing platform to annotate the online application template string at least in part by storing an annotation related to a region of the template string at a storage location associated with the region.

34. The article of claim 25, wherein the storage medium has stored thereon further instructions executable by the processor of the computing platform to construct document components from the online application template string at least in part by attaching one or more LiveRanges to the document components.

35. The article of claim 34, wherein the storage medium has stored thereon further instructions executable by the processor of the computing platform to construct document components from the online application template string at least in part by passing the template string to a web browser.

36. The article of claim 25, wherein the storage medium has stored thereon further instructions executable by the processor of the computing platform to determine an innermost enclosing LiveRange to obtain a pointer to an appropriate data record.

37. A method, comprising:
detecting an event related to an online application; and
determining an innermost enclosing LiveRange to obtain a pointer to a data record associated with an electronic document component at least in part in response to said detecting the event.

38. The method of claim 37, the event to invoke an even handler in the online application, wherein said determining the innermost enclosing LiveRange to obtain the pointer comprises determining the innermost enclosing LiveRange at least in part in response to the event handler requesting information identifying the data record.

39. The method of claim 38, further comprising identifying the data record associated with the electronic document at least in part by evaluating the pointer of the innermost enclosing LiveRange.

40. An apparatus, comprising:
a processor to detecting an event related to an online application, the processor further to determining an innermost enclosing LiveRange to obtain a pointer to a data record associated with an electronic document component at least in part in response to said detecting the event.

41. The apparatus of claim 40, the event to invoke an even handler in the online application, the processor further to determining the innermost enclosing LiveRange to obtain the pointer at least in part in response to the event handler requesting information identifying the data record.

42. The apparatus of claim 41, the processor further to identify the data record associated with the electronic document at least in part by evaluating the pointer of the innermost enclosing LiveRange.

43. An article, comprising: a storage medium having stored thereon instructions executable by a processor of a computing device to:
detect an event related to an online application; and
determine an innermost enclosing LiveRange to obtain a pointer to a data record associated with an electronic document component at least in part in response to said detecting the event.

44. The article of claim 43, the event to invoke an even handler in the online application, wherein the storage medium has stored thereon further instructions executable by the processor to determine the innermost enclosing LiveRange to obtain the pointer at least in part in response to the event handler requesting information identifying the data record.

45. The article of claim 44, wherein the storage medium has stored thereon further instructions executable by the processor to identify the data record associated with the electronic document at least in part by evaluating the pointer of the innermost enclosing LiveRange.
